(19) United States
(12) Patent Application Publication
(10) Pub. No.: US 2011/0055113 A1
(43) Pub. Date: Mar. 3, 2011

(54) METHOD AND SYSTEM FOR MANAGING SPREAD ORDERS

(76) Inventors: Conor Cunningham, London (GB); Markus Reith, Castrop-Rauxel (DE); Hicham Medkouri, London (GB)

(21) Appl. No.: 12/732,915

(22) Filed: Mar. 26, 2010

Related U.S. Application Data
(60) Provisional application No. 61/237,774, filed on Aug. 28, 2009.

(51) Int. Cl. G06Q 40/00

(52) U.S. Cl. 705/36 R; 705/37

(57) ABSTRACT

A system and method of executing a spread order trade is provided. The system and method of the present invention provide a profit and loss neutral model configured to dynamically and iteratively rebalance the trades associated with a spread order based on changing market conditions. According to an embodiment of the present invention, a vector-based target volume ratio is maintained by rebalancing a plurality of trades associated with instruments (or legs) of the spread order, in view of changes in the underlying markets. Maintaining a target volume ratio allow the spread order to be traded according to a profit and loss neutral model.

### CROSS-REFERENCE TO RELATED APPLICATION

This application claims the benefit of U.S. Provisional Patent Application No. 61/237,774 filed Aug. 28, 2009 titled, “Method and System for Managing Spread Orders,” which is herein incorporated by reference.

### FIELD OF THE INVENTION

The present invention relates generally to a method and system for managing spread orders, and more particularly to a method and system for providing a profit and loss neutral model configured to dynamically and iteratively rebalance trades related to spread orders.

### BACKGROUND OF THE INVENTION

Spread orders are used as an investment strategy when facilitating trades involving a group of multiple instruments or a spread portfolio. When conducting a spread order, the aim is to exploit relative valuation differences between the instruments rather than absolute price movement by one or more instruments. Typically, spread orders comprise buy and sell orders for one or more of the instruments within a spread portfolio, thereby attempting to offset absolute price movement among the associated instruments.

To manage spread orders, order volumes for each instrument within a spread portfolio must be kept within a target volume ratio at all times. Failure to do so could result in exposure to risk associated with absolute price movements by one or more instruments. The risk of failing to monitor the target volume ratio arises in particular in markets where a large spread order has to be broken down into a series of smaller orders. As a result, each order must be monitored to reduce possible unintended exposure.

Despite the need to manage spread orders, the prior art lacks an effective method or system that provides an iterative process for monitoring spread orders and maintaining the target volume ratio of the underlying instruments.

### SUMMARY OF THE INVENTION

The present invention relates to a system and computer-implemented method for managing spread orders (i.e., a collection of instruments or legs) having an underlying relationship which drives the manner in which the instruments are traded. Generally, a spread order is a combination of individual futures orders (i.e., legs or instruments) that are inter-related to create a commodity trading strategy. Optionally, the legs may be based in different markets relative to one another.

Spread orders typically comprise buy and sell orders relating to the instruments which offset absolute price movements against each other by taking advantage of the relative price differences between the instruments. In order to efficiently manage a spread order, it is advantageous to maintain a desired order volume ratio for the instruments in the spread order. In practice, the desired or target volume ratio might be disrupted by a number of factors, events or actions in respective instrument markets, such as, for example, the unavailability of a desired order quantity, or the inability to execute a desired order, in whole or in part. The term ‘target volume ratio’ is intended to include, but is not limited to, a desired ratio, in terms of trading volume, between the various instruments in a spread trade portfolio wherein maintaining such a ratio may result in a profit and lose neutral spread order.

The system and method of the present invention provide a profit and loss neutral model configured to dynamically and iteratively rebalance the trades associated with a spread order based on changing market conditions. A profit and loss neutral trading strategy is indifferent to the absolute levels of the market, but seeks to achieve returns, with regard to a target volume ratio, thereby providing a net monetary benefit equal to or greater than zero. The profit and loss neutral feature of the system and method of the present invention provides for adjustments to the trades associated with the spread order to offset variations to balance the portfolio and maintain a desired profit and loss neutral model.

According to an embodiment of the present invention, the system and method establish a desired or target volume ratio for the spread order, and represent the target volume ratio using a vector-based modeling. The use of a vector-based volume ratio model for the instruments associated with a spread order allows the system and method of the present invention to dynamically adjust the spread order trading to maintain the target volume ratio within a pre-defined and acceptable deviation.

In operation, the system and method may include a graphical user interface accessible by a user/trader. The trader may enter information and parameters relating to the spread order (e.g., the target price and target volumes for the instruments). Based on the inputted parameters, the system and method determine a target volume ratio represented by a vector-based model. The system and method may then execute trades on the appropriate exchanges in a manner which is profit and loss neutral, while maintaining the target volume ratio. According to an embodiment of the present invention, the vector-based target volume ratio is dynamically adjusted and maintained by rebalancing the volumes of the instruments (or legs) of the spread order, in view of changes in the underlying markets.

Accordingly, an embodiment of the present invention provides a system and method for executing a spread order trade, comprising the steps of selecting a spread portfolio comprising a plurality of legs, calculating a target volume ratio associated with the spread portfolio, determining a total traded vector associated with the spread portfolio wherein the total traded vector is a sum of all trades associated with the spread portfolio, calculating a total suggested sub-order vector based on a difference between the target volume ratio and the total traded vector wherein the total suggested sub-order vector comprises a suggested sub-order vector for each of the plurality of legs in the spread portfolio, and executing the spread order trade in accordance with the total suggested sub-order vector.

### BRIEF DESCRIPTION OF TILE DRAWINGS

The present invention will be more readily understood from the detailed description of exemplary embodiments presented below considered in conjunction with the attached drawings, of which:

FIG. 1 depicts an exemplary communications network utilized to manage spread orders, in accordance with an embodiment of the present invention;

FIG. 2 illustrates an exemplary method for managing spread orders, in accordance with an embodiment of the present invention;

FIG. 3 depicts a graph illustrating an exemplary method for maintaining a target volume ratio, in accordance with an embodiment of the present invention; and

FIG. 4 illustrates a graphical user interface that may be used to manage a spread order.

### DETAILED DESCRIPTION OF THE INVENTION

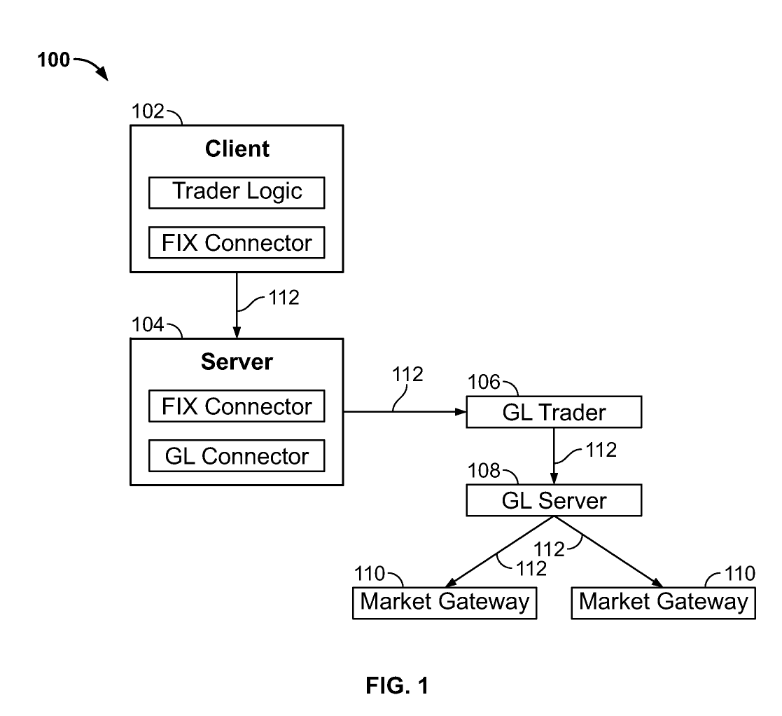

An exemplary system 100 for implementing the spread order management and related processes of the present invention is illustrated in FIG. 1. It should be noted that the network illustrated in FIG. 1 is provided to assist in demonstrating the novel aspects of the present invention and is not presented for purposes of limitation. In accordance with a preferred embodiment of the present invention, system 100 may be comprised of a Client Computer Module 102 having a Trader Logic Module and Financial Information Exchange (FIX) Connector installed thereon, a Server 104, or server computer, having a FIX connector and GL (“Global Trading”) Connector installed thereon, a GL Trader Computer Module 106 (hereinafter “GL Trader”), a GL Server 108, and one or more Market Gateways 110. The client computer is configured to allow a trader to manage one or more spread orders. FIX connectors and GL connectors may be used to connect components of system 100. The FIX connectors allow for communication between the Client Computer Module 102 and the Server 104, while the GL Connector facilitates communication between the Server 104 and the GL Trader Computer Module 106. The term ‘computer’ is intended to include any data processing device, such as a desktop computer, a laptop computer, a mainframe computer, a personal digital assistant, a server, a handheld device, or any other device configured to process data. The term ‘computer module’ is intended to include, but is not limited to, one or more computers configured to execute one or more software programs configured to perform one or more functions.

The embodiment of the present invention illustrated in FIG. 1 demonstrates the Server 104 connected to the GL Trader 106, wherein the GL Trader 106 is configured to facilitate the execution of trades in one or more markets. One having ordinary skill in the art will appreciate that alternative trading conduits, services, or third parties may be relied on to execute trades in accordance with alternative embodiments of the present invention. These components may be connected via a communication means 112. Communication means 112 may be achieved through the use of any well-known wired and wireless networking and data management protocols.

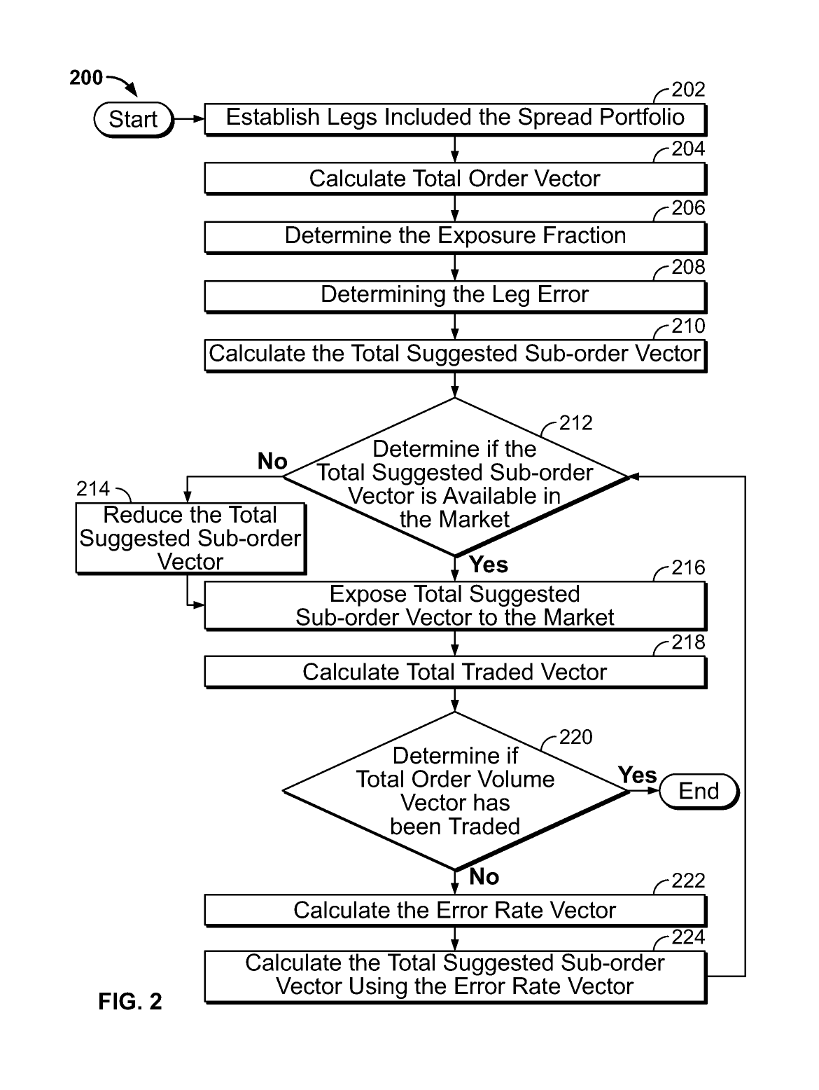

In FIG. 2, a process flow 200 illustrates the steps executed by the spread order management system, according to an embodiment of the present invention. Process flow 200 begins, at step 202, by selecting one or more instruments, or legs, to include in a given spread order. For example, as a result of step 202, a given spread order (hereinafter “Example Spread Order”) may be created and include Legs A, B, C, and D. A user may select legs to include in a spread order based on his or her investment strategies. The collection of legs included in a given spread order may be selected to facilitate a profit and loss neutral strategy.

Following the selection of the legs to be included in the spread order, at step 202, process flow 200 continues by calculating the total order vector, at step 204. The total order vector represents the aggregate of the order volumes for each leg included in a given spread order. The total order vector (\vec{V}) may be represented as:

$${V}^{->} = ( \begin{matrix}{v}_{0} \\ {v}_{1} \\ {v}_{2} \\ … \\ {v}_{n}\end{matrix} )$$

wherein vₒ, v₁, v₂, . . . , vₙ represent the order vector for each individual leg included in the given spread order. The order vector for each leg represents the number of shares of a given leg that is to be traded in the market while maintaining the target volume ratio.

Returning to the Example Spread Order, in step 204, the order vector for each of Legs A, B, C, and D is determined to ensure that the target volume ratio is maintained. As a result, it may be determined that the following order vectors should be traded, Leg A buy 100 shares; Leg B sell 40 shares; Leg C sell 120 shares; and Leg D buy 200 shares. As a result, the total order vector for the Example Spread Order is represented as follows:

$${V}^{->} = ( \begin{matrix}100 \\ - 40 \\ - 120 \\ 200\end{matrix} )$$

The total order vector represents the desired or target volume ratio capable of producing the desired profit and loss neutral model. During certain trading iterations, maintaining the target volume ratio may not be feasible, as a result of disruptions in trading strategies caused by a number of factors, events or actions in respective instrument markets, such as, for example, the unavailability of a desired order quantity, or the inability to execute a desired order, in whole or in part. As such, following a trading iteration wherein the target volume ratio was not maintained, subsequent trades are utilized to realign and recalibrate to the target volume ratio. This may be accomplished by rebalancing the leg order volumes within a spread order.

The spread order management process described in FIG. 2 is an iterative process whereby only a portion of the order volume for each leg is exposed to the market during a given iteration. As a result, numerous iterations of the trades, or trading iterations, may be executed before the total order vector is traded.

In step 206, an exposure fraction utilized during the spread order management process is determined. The term ‘exposure fraction’ is intended to include, but is not limited to, a percentage of an order volume, which is determined by the user, to be exposed to the market in any single trading iteration. The exposure fraction is used to calculate the portion of order volume for each leg to be exposed to the market during a given trading iteration. The exposure fraction is determined by the trader of the spread order according to his or her tolerance for execution risk, or the risk of market price fluctuation between the authorization and the actual execution of a trade. The exposure fraction is determined based on two factors: a) the liquidity of the underlying instrument being traded; and b) the total size of the order. The exposure fraction may be determined by the trader, at his or her discretion, based on liquidity in the market at time of trade, size of the overall order and tolerance of the trader for execution risk. According to certain embodiments of the present invention, the exposure fraction may be re-established for each trading iteration. As discussed further below, the exposure fraction is used to adjust the total order vector by setting the maximum volume exposed to the market during a given trading iteration.

Process flow 200 continues by determining a leg error, at step 208. The leg error is intended to include, but is not limited to, the maximum deviation from the desired order vector for a given leg if the desired order quantities are not available in the market. The leg error may be relied on when determining the order volume exposed to the market for a given leg. For example, if the order vector for Leg A required the sale of 100 shares and the leg error is 5%, then it would be acceptable to initiate a trade of between 95-105 shares for Leg A. Given that a larger leg error may result in an increased diversion from a target volume ratio, the leg error may be selected by the trader based on their tolerance for risk or other strategic investment factors.

Following the determination of the leg error at step 208, process flow 200 continues by calculating a total suggested sub-order vector, at step 210. The total suggested sub-order vector represents the sum of all suggested sub-order vectors related to each leg within a given spread order for a single trading iteration. The total suggested sub-order vector (\vec{S}) may be represented as:

$${S}^{->} = ( \begin{matrix}{s}_{0} \\ {s}_{1} \\ {s}_{2} \\ … \\ {s}_{n}\end{matrix} )$$

wherein s₀, s₁. s₂, . . . sₙ represent the suggested sub-order vector for each leg included in a given spread order. Each suggested sub-order vector may be based on the order vector for a given leg, exposure fraction and the leg error. Suggested sub-order vector may represent the maximum percentage of the total order volume that may be traded in a single trading iteration.

For example, assuming an exposure fraction of 10% for Example Spread Order, each trading iteration exposes 10% of the order volume from each leg to the market. Accordingly, 10% of the order volume is considered the suggested sub-order vector. As a result, during a single trading iteration, the suggested sub-order vector for the Example Spread Order are: Leg A buy 10 shares; Leg B sell 4 shares; Leg C sell 12 shares; and Leg D buy 20 shares.

According to certain embodiments of the present invention, the suggested sub-order vector may define the order characteristics for an associated leg. The order characteristics may include, but are not limited to, the identity of the leg, number of shares traded, type of trade (e.g., buy, sell), and/or market upon which the leg will be traded. For example, the order characteristics could define a suggested sub-order vector calling for the sale of 500 shares of ABC stock on the New York Stock Exchange.

Having established the total suggested sub-order vector in step 210, process flow 200 continues by determining if the total suggested sub-order vector is available in the market, at step 212. The total market vector \vec{M} may represent the volume currently available in the market for each of the one or more legs included in a spread order. The total market vector (\vec{M}) may be represented as:

$${M}^{->} = ( \begin{matrix}{m}_{0} \\ {m}_{1} \\ {m}_{2} \\ … \\ {m}_{n}\end{matrix} )$$

wherein m₀, m₁, m₂, . . . mₙ represent the volume currently available in the market for each leg included in the spread order. The volume currently available in the market may be reflective of market demand for a given leg, external market trends, or other forces effecting market demand.

When it is determined that the total suggested sub-order vector is available in the market, process flow 200 continues at step 216, wherein the total suggested sub-order vector is exposed to the market. However, if the total suggested sub-order vector is not available in the market, process flow 200 reduces the total suggested sub-order vector, in step 214. According to an embodiment of the present invention wherein process flow 200 is executed through the use of system 100, steps 202-214 may be executed by Client Computer Module 102 and/or Server 104.

According to step 214, the total suggested sub-order vector may be reduced to compensate for the current market availability of one or more legs within a spread order. When reducing the total suggested sub-order vector each suggested sub-order vector related to the legs within the spread order may be adjustment to maintain the target volume ratio. The process of adjusting the suggested sub-order vectors begins by adjusting the leg within the spread order which requires the greatest alteration to its suggested sub-order vector. Following this adjustment, the remaining suggested sub-order vectors are adjusted to compensate for the initial alteration while still maintaining the target volume ratio.

By way of example, in reference to the Example Spread Order described above, assume that the volume currently available in the market is as follows: Leg A 200 shares may be sold; Leg B 1 share may be purchased; Leg C 80 shares may be purchased; and Leg D 920 shares may be sold. As described above, the suggested sub-order vector for Leg B is to sell 4 shares. As a result, the suggested sub-order vector for Leg B must be altered to compensate for the volume currently available in the market. Therefore, the suggested sub-order vector will be reduced for each Leg to compensate for the deficiency in the market with respect to Leg B. The suggested sub-order vectors may be adjusted as follows: Leg A buy 2 shares; Leg B sell 1 share; Leg C sell 3 shares; and Leg D buy 5 shares.

During certain trading iterations, market availability may prohibit reducing the total suggested sub-order vector, or individual suggested sub-order vectors, while still maintaining the target volume ratio. To compensate, the leg error may allow for some deviation from the target volume ratio. As a result, the suggested sub-order vectors may be adjusted within an acceptable deviation despite the fact that such an adjustment will not maintain the target volume ratio.

Following the reduction of the total suggested sub-order vector at step 214, the total suggested sub-order vector is exposed to the market, in step 216. During the process of exposing the suggested sub-order vector to the market, an attempt is made to trade the individual suggested sub-order vectors for each leg. These trades may be executed by the system upon which the spread order is managed. In an alternative embodiment of the present invention, the spread order management system could request a third party, or external trading platform, to complete the necessary trades. According to an embodiment of the present invention wherein process flow 200 is executed through the use of system 100, step 216 may be executed by GL Trader 106, GL Server 108 and/or Market Gateways 110.

Following each trading iteration, a total traded vector is calculated, at step 218. The total traded vector represents the sum of all individual trade volumes relating to a given spread order, wherein an individual trade volume represents the trades successfully executed for a given leg during a trading iteration. An individual trade volume for a given leg may not equal the suggested sub-order vector calculated in step 214 or 210 as a result of changing market demand, failed trades, or partially executed trades.

With respect to the Example Spread Order, assume the following trades have been executed during the first two trading iterations: Leg A buy 2 shares; Leg B sell 1 shares; Leg C sell 3 shares; and Leg D buy 5 shares. As a result, the total traded vector would be based on the following trades: Leg A 4 shares purchased; Leg B 2 shares sold; Leg C 6 shares sold; and Leg D 5 share purchased.

Having calculated the total traded vector, at step 218, process flow 200 continues by determining if the total order vector has been successfully traded, at step 220. The total order vector has been successfully traded when the total traded vector equals the total order vector. This may occur following one or more trading iterations. Process flow 200 may terminate if it is determined that the total order vector has been traded. According to alternative embodiments of the present invention, process flow 200 may terminate even if the total order vector has not been traded. For example, the process may terminate after a certain number of trading iteration or if a certain percentage of the total order vector has been traded.

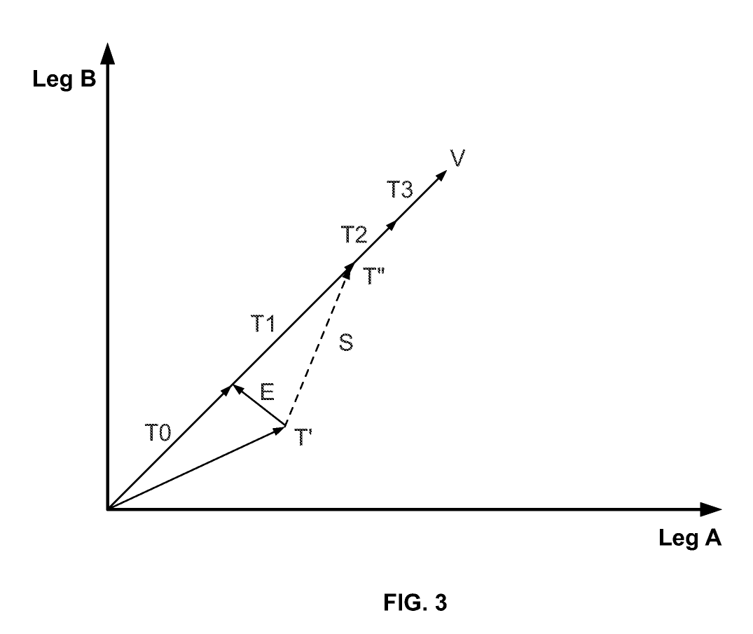

Following a trading iteration wherein the total order vector has not been fully exhausted, process flow 200 continues to step 222, wherein an error rate vector is calculated. The error rate vector represents the sum of all error volumes related to each leg with in a given spread order for a single trading iteration. The error rate vector (\vec{E}) may be represented as:

$${E}^{->} = ( \begin{matrix}{e}_{0} \\ {e}_{1} \\ {e}_{2} \\ … \\ {e}_{n}\end{matrix} )$$

wherein e₀, e₁. e₂, . . . eₙ represent the error volume for each leg included in the given spread order. The error rate vector measures the deviation between the target volume ratio and the total traded volume. This deviation may result from the unavailability of a desired order quantity, or the inability to execute a desired order, in whole or in part. To compensate for such a deviation, the error rate vector is utilized to guide the total traded vector toward the target volume ratio. This process is further described in FIG. 3.

With respect to the Example Spread Order, as described above, Leg A was permitted to deviate from the target vector as a result of a deficiency in the market with respect to Leg B. Therefore, an error rate vector is used to realign the total traded volume to the target volume ratio as follows: Leg A +0.5 shares; Leg B 0 shares; Leg C 0 shares; and Leg D 0 shares.

As illustrated in FIG. 3, total order vector V is represented by five trading iterations (T0, T1, T2, T3, T4). Under ideal market conditions wherein each trading iteration adheres to the target volume ratio, the total traded vector would mirror the total order vector. FIG. 3 illustrates five trading iterations however alternative embodiments of the present invention may utilize greater or fewer trading iterations.

FIG. 3. illustrates the spread order trading process associated with total order vector V following two trading iterations, T0 and T1. The total order vector V represents the trading strategy for a spread order comprising two legs, Leg A and Leg B. As illustrated in FIG. 3, following trading iteration T0, the total traded volume T′ deviates from the total order vector, thereby demonstrating that the target volume ratio has not been maintained. This deviation is measured by error vector E, wherein error vector E is configured to bring back the total traded volume T′ on the shortest path to the total order vector V. The use of the error rate to realign the total suggested sub-order vector provides for dynamic and iterative rebalancing of trade parameters based on fluctuating conditions in the underlying markets.

Therefore, the error vector E is be used to establish the total suggested sub-order vector S for subsequent trading iteration T1. As illustrated in FIG. 3, T′ represents the total traded volume after trading iteration T0 and T″ represents the total traded volume after trading iteration T1. The total suggested sub-order vector S, or corrective vector, is configured to realign the total traded volume T″ with the target volume ratio after trading iteration T1. FIG. 3. illustrates this realignment process following a single trading iteration, however, under certain market circumstances several trading iterations may be required to realign the total traded volume with the target volume ratio. Furthermore, certain market circumstances may prohibit complete realignment. According to the embodiment of the present invention described in FIG. 2, the process of calculating a total suggested sub-order vector through the use of an error rate vector occurs at step 224.

With respect to the Example Spread Order, assume that the volume currently available in the market is as follows: Leg A 200 shares may be sold; Leg B 1 share may be purchased; Leg C 80 shares may be sold; and Leg D 920 shares may be purchased. As described above, Leg A was permitted a deviation from the target volume ratio and the error rate vector required to commentate for this deviation was determined to be: Leg A +0.5 shares; Leg B 0 shares; Leg C 0 shares; and Leg D 0 shares. Therefore, the suggested sub-order vector for the Example Spread Order would be based on the following suggested sub-order vectors: Leg A buy 3 shares; Leg B sell 1 share; Leg C sell 3 share; and Leg D buy 5 shares.

According to certain embodiments of the present invention, a higher priority may be placed on attending to the error vector portion during a trading iteration so as to more quickly return the total traded volume to the target volume ratio. The error vector may be prioritized by subtracting the error vector from the available market demand prior to calculating the total suggested sub-order vector. As a result, the market demand required to compensate for the error vector is accounted for prior to calculating the total suggested sub-order vector. Therefore, instead of calculating the total suggested sub-order vector based on market demand M, the total suggested sub-order vector is calculated based on market demand M′, wherein M′=M−E.

Following the calculation of the total suggested sub-order vector using the error rate vector, at step 222, process flow 200 returns to step 212 wherein a determination is made whether the total suggested sub-order vector is available in the market. Iteration through steps 212 and 222 may continue until the total order vector is successfully traded. According to an embodiment of the present invention wherein process flow 200 is executed through the use of system 100, steps 218-224 may be executed by Client Computer Module 102 and/or Server 104.

As a result of process flow 200, a spread order may be traded through the use of a self-correcting iterative process by dividing spread orders into a series of sub-orders in a way which minimizes a deviation from the target volume ratio. During each trading iteration, any deviation from the target volume ratio is accounted for through the error rate vector and an effort is made to compensate for this deviation in any subsequent trading iterations.

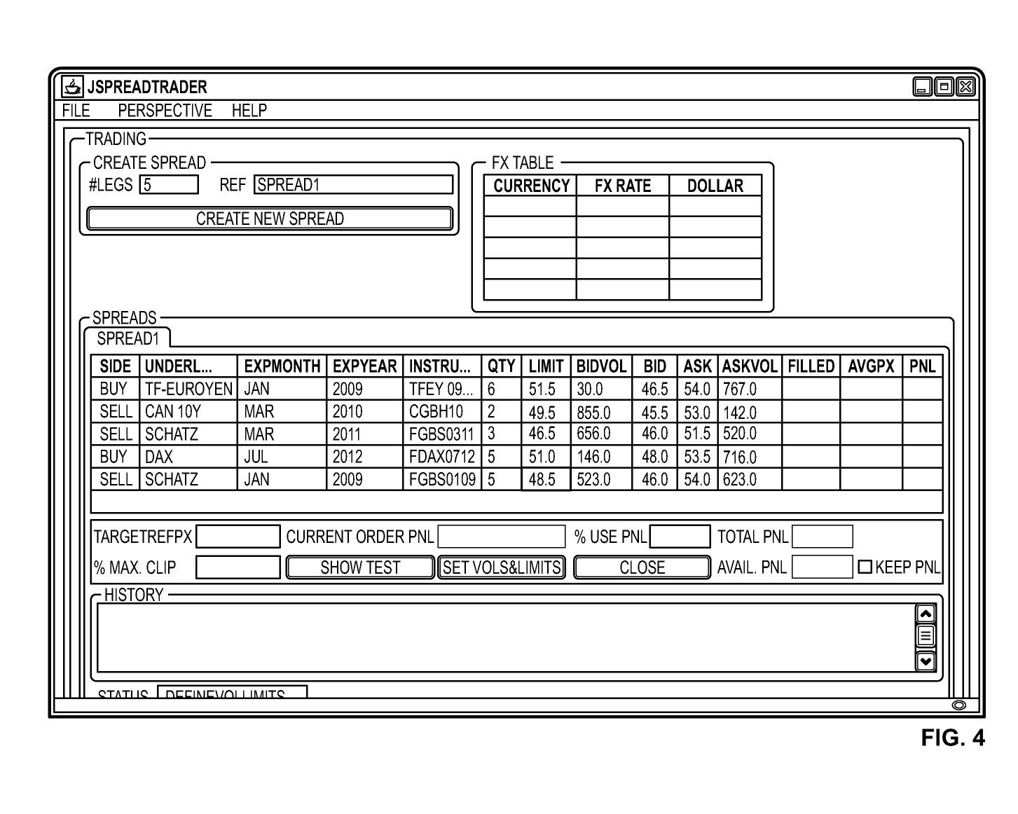

Embodiments of the present invention may include an electronic graphical user interface wherein the trader of a spread order controls certain parameters of the spread order trades, such as the exposure fraction or leg error. FIG. 4 illustrates an example of a graphical user interface used to manage a spread order trade. The graphical user interfaces provides the trader with information regard each leg within the spread order in addition to other relevant data. The graphical user interface could be displayed on a computer, workstation, wireless handset, or other like device.

It is to be understood that the exemplary embodiments are merely illustrative of the invention and that many variations of the above-described embodiments may be devised by one skilled in the art without departing from the scope of the invention.

What is claimed is:

1. A computer-implemented method of executing a spread order trade, comprising:
selecting, by a computer, a spread portfolio comprising a plurality of legs;
calculating, by the computer, a target volume ratio associated with the spread portfolio;
determining, by the computer, a total traded vector associated with the spread portfolio, wherein the total traded vector is a sum of all trades associated with the spread portfolio;
calculating, by the computer, a total suggested sub-order vector based on a difference between the target volume ratio and the total traded vector, wherein the total suggested sub-order vector comprises a suggested sub-order vector for each of the plurality of legs in the spread portfolio; and
executing, by a computer, the spread order trade in accordance with the total suggested sub-order vector.

2. The computer-implemented method of claim 1, further comprising:
updating, by the computer, the total traded vector associated with the spread portfolio, following the execution of the spread order trade;
calculating, by the computer, a second total suggested sub-order vector based on a difference between the target volume ratio and the updated total traded vector; and
executing, by the computer, a second spread order trade in accordance with the second total suggested sub-order vector.

3. The computer-implemented method of claim 1, wherein the difference between the target volume ratio and the total traded vector is represented by an error vector.

4. The computer-implemented method of claim 1, wherein following the calculation of the total suggested sub-order vector, further comprising:
selecting, by the computer, an exposure fraction, and
reducing, by the computer, the total suggested sub-order vector based on the exposure fraction.

5. The computer-implemented method of claim 1, further comprising:
determining, by the computer, a market tolerance for the total suggested sub-order vector; and
reducing, by the computer, the total suggested sub-order vector based on the market tolerance.

6. The computer-implemented method of claim 1, wherein the suggested sub-order vector defines one or more order characteristics.

7. The computer-implemented method of claim 1, wherein the suggested sub-order vector for at least one of the plurality of legs is adjusted in accordance with a profit and loss neutral trading strategy.

8. The computer-implemented method of claim 1, further comprising:
selecting, by the computer, a leg error; and
determining, by the computer, if the suggested sub-order vector for each of the plurality of legs is within the leg error.

9. The computer-implemented method of claim 8, wherein the suggested sub-order vector is adjusted following a determination that the suggested sub-order vector for each of the plurality of legs is not within the leg error.

10. A system for managing a spread order, comprising:
a client computer module configured to:
select a spread portfolio comprising a plurality of legs,
calculate a target volume ratio associated with the spread portfolio,
calculate a total traded vector associated with the spread portfolio, wherein the total traded vector is a sum of all trades associated with the spread portfolio, and
calculate a total suggested sub-order vector based on a difference between the target volume ratio and the total traded vector; and
a trader computer module configured to execute the spread order trade in accordance with the total suggested sub-order vector.

11. The system of claim 10, wherein the client computer module is further configured to:
update the total traded vector associated with the spread portfolio, following the execution of the spread order trade;
calculate a second total suggested sub-order vector based on a difference between the target volume ratio and the updated total traded vector; and
execute a second spread order trade in accordance with the second total suggested sub-order vector.

12. The system of claim 10, wherein the difference between the target volume ratio and the total traded vector is represented by an error vector.

13. The system of claim 10, wherein the client computer module is further configured to:
select a leg error; and
determine if the suggested sub-order vector for each of the plurality of legs is within the leg error.

14. The system of claim 10, wherein the client computer module is further configured to:
determine a market tolerance for the total suggested sub-order vector; and
reduce the total suggested sub-order vector based on the market tolerance.

15. The system of claim 10, wherein the suggested sub-order vector for at least one of the plurality of legs is adjusted in accordance with a profit and loss neutral trading strategy.

16. The system of claim 10, wherein the suggested sub-order vector for at least one of the plurality of legs is adjusted in accordance with a profit and loss neutral trading strategy.

17. The system of claim 10, wherein the client computer module is further configured to:
select a leg error; and
determine if the suggested sub-order vector for each of the plurality of legs is within the leg error.

18. The system of claim 17, wherein the suggested sub-order vector is adjusted following a determination that the suggested sub-order vector for each of the plurality of legs is not within the leg error.
